(19) United States
(12) Patent Application Publication
(10) Pub. No.: US 2005/0154741 A1
(43) Pub. Date: Jul. 14, 2005

(54) Methods and computer systems for workflow management

(76) Inventors: Cedric Hebert, Mouans Sartoux (FR); Roger Kilian-Kehr, Damstadt (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/980,273

(22) Filed: Nov. 4, 2004

(30) Foreign Application Priority Data
Nov. 5, 2003 (EP) 03025242.3

(51) Int. Cl. G06F 7/00

(52) U.S. Cl. 707/100

(57) ABSTRACT

Methods and computer systems are provided for workflow management. A workflow engine may be provided that creates workflow items. Each workflow item may include a self descriptive part that specifies details for generating a device independent representations of a corresponding workflow item. Further, a workflow manager may be provided that generates the device independent representation based on the self descriptive part.

### BACKGROUND

1. Field of the Invention

The present invention generally relates to electronic data processing, and, more particularly, relates to methods, computer program products and systems for workflow management.

2. Background Information

In general, integrating mobile devices into workflow management involves adaptation of workflow application user interfaces to fit the capabilities of the various mobile devices. For example, the user interface (UI) of a workflow application related to vacation approval when executed on a desktop computer typically looks different from the corresponding UI on a personal digital assistant (PDA) or a mobile phone.

The publication “On Integrating Mobile Devices Into A Workflow Management Scenario” (Proc. 11th International Workshop on Database and Expert Systems Applications (DEXA 2000); Published by IEEE Computer Society, Los Alamitos, Calif., Page(s) 186-192) addresses this problem by proposing a Java Border Service Architecture (JBSA). A runtime analysis is applied to the presentation layer of a workflow application and its description in an abstract data representation in a specially designed XML dialect. A set of device-dependent XSL transformation rules is applied to the abstract description to transfer (render) the abstract description into a UI description suitable for a specific device. As part of the analysis, all user interface primitives (push buttons, text fields etc.), are identified at an operating system level by means of UI object hierarchy inspection. No semantic analysis is performed and thus no “valence” will be given to identified elements. Type and unique identifier of each user interface primitive is derived and registered to allow for later access to each GUI element. Results of the runtime analysis are assembled and form a “snapshot” in a well defined descriptive language.

This approach requires extensive runtime analysis of the presentation layer of a workflow application, which is time consuming. Further, complex transformation rules are needed to transform the abstract UI description layer into a device compliant description.

### SUMMARY

In view of the foregoing, there is a need to improve the generation of workflow task user interfaces for executing workflow tasks on multiple devices. Workflow tasks are usually part of a workflow application and will also be referred to as “workflow items” hereinafter.

Workflow management computer systems, workflow management methods, and workflow management computer program products according to embodiments of the present invention may provide improved generation of workflow task user interfaces for executing workflow tasks on multiple devices.

In one embodiment, a computer system is provided that includes a workflow engine for creating workflow items. A workflow item has a self descriptive part that specifies details for generating a device independent representation of the respective workflow item. The generation of the device independent representation is performed by a workflow manager based on the self descriptive part.

By using self descriptive workflow items, the workflow manager may generate a functional description of the user interface that relates to the workflow item. A client device that connects to the workflow manager to retrieve the workflow item can transform the functional description in the form of a device independent representation into a device specific representation. This device specific representation can be rendered into an appropriate user interface on the client device.

Self-descriptive workflow items eliminate the need for extensive runtime analysis of the presentation layer of a workflow application, in order to generate a device specific UI of the workflow application.

The above-mentioned embodiments and features of the invention may be realized and attained by means of the elements and combinations particularly pointed out in the appended claims. Also, the described combination of features of the invention is not to be understood as a limitation, and all features can be combined in other arrangements without departing from the spirit of the invention. It is to be understood that both the foregoing general description and the following detailed description are exemplary and explanatory only and are not restrictive of embodiments of the invention as described.

### BRIEF DESCRIPTION OF THE DRAWINGS

FIG. 1 is a block diagram of an exemplary computer system for workflow management that includes a workflow engine and a workflow manager, consistent with an embodiment of the present invention;

FIG. 2 shows, by way of example, details of a workflow manager using a rule set, consistent with an embodiment of the present invention;

FIG. 3 shows, by way of example, a workflow manager including a notifying component, consistent with an embodiment of the present invention; and

FIG. 4 is a flow chart of an exemplary method for performing workflow management, consistent with an embodiment of the present invention.

### DESCRIPTION OF THE EMBODIMENTS

Reference will now be made in detail to exemplary embodiments of the invention illustrated in the accompanying drawings. Wherever possible, the same reference numbers will be used throughout the drawings to refer to the same or like parts.

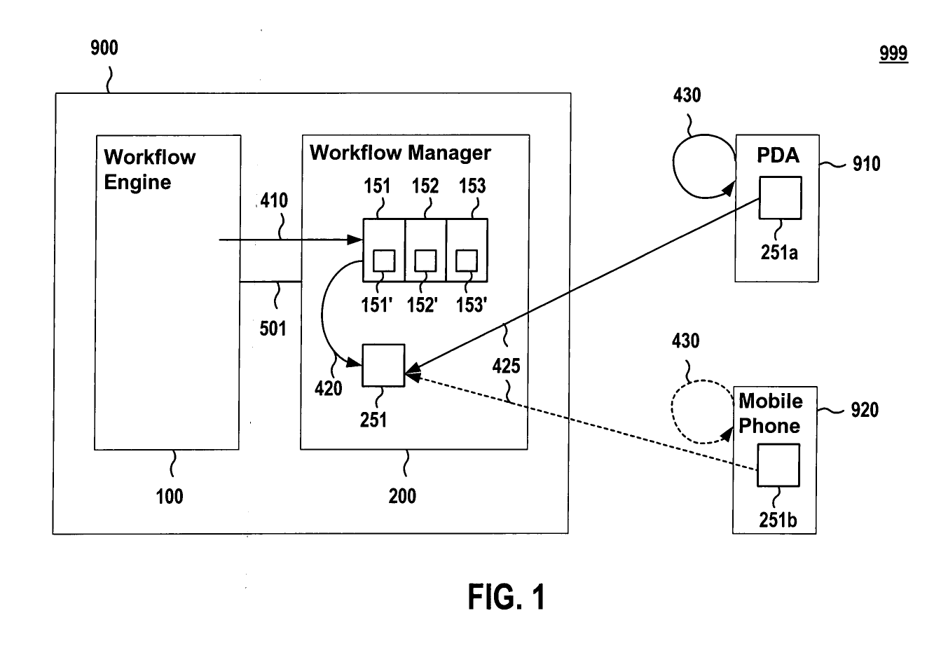

FIG. 1 is a block diagram of an exemplary computer system 999 for workflow management that includes a workflow engine 100 and a workflow manager 200, consistent with an embodiment of the present invention. The workflow engine 100 and the workflow manager 200 can communicate over an interface 501 and can both be run by one or more computers 900. The computer system 999 can include further computing devices 910, 920, such as client devices like mobile phones, PDAs, desktop computers, laptop computers, etc. These devices can communicate with the workflow computer 900 over a network, such as a local area network (LAN), a wide area network (WAN) or the Internet. In the case of using mobile devices, at least part of the network can be operated by wireless technology.

As shown in FIG. 1, the workflow engine 100 may create one or more workflow items (151, 152, 153). For example, when a user of the computer system 999 applies for vacation, the workflow engine 100 may create a corresponding workflow item for the user's manager. According to one embodiment, the work flow item may represent a small application that allows the manager to approve or reject the vacation request. Each workflow item 151, 152, 153 has a self descriptive part 151′, 152′, 153′ that specifies details for generating a device independent representation 251 of the workflow item 151. The self descriptive part 151′, 152′, 153′ includes metadata for defining at least a part of the semantics of the workflow item 151, 152, 153. In the example above, the workflow item can have a generic YES/NO field that is used for approval or rejection by the manager.

According to one embodiment, the workflow manager 200 can generate the device independent representations 251 of the workflow items 151 by using the self-descriptive part 151′. The device independent representations 251 are then transformed 430 into device specific representations 251a, 251b.

In another embodiment, the transformation 430 is performed by the client device 910 (e.g., by a browser of the client device) that is used to access 425 the device independent representations 251 of the workflow item 151 (illustrated by solid arrows 425, 430). In an alternative embodiment, the transformation 430 can be performed by further client devices 920 (illustrated by dashed arrows 425, 430). According to yet another embodiment, the transformation 430 can be done by the workflow manager 200.

The workflow manager 200 can serve as a repository for a user to access workflow tasks from various devices, such as, PDA, desktop, mobile phone, etc. For example, when the manager uses a mobile phone for executing the workflow item, the user interface of the workflow item looks typically quite different from what it looks like on a desktop PC or on a PDA.

According to one embodiment, each of the client devices interprets the device independent representation 251 in a specific way to meet the restrictions or capabilities (e.g., display area) of the device. Therefore, the device dependent representations 251a, 251b in general will not be equal.

By way of example, workflow parameters in the workflow engine 100 may be basic character strings. Special characters and/or keywords can be defined as specific workflow parameters, to convey semantic information (metadata) about the workflow item to the workflow manager 200 where the information can be further processed.

The following example illustrates an implementation of a workflow item having a self-descriptive portion 151′.

Assume a travel planning workflow scenario, where the end user should receive a workflow item that allows him/her to choose how to be identified at the airport for his/her electronic ticket. For example, possible choices can be credit card number, ID card or passport.

The workflow engine 100 of the computer system 900 may create the workflow item 151 including a self-descriptive parameter 151′ (e.g., META_IDENTIFIED_BY parameter) that provides the information needed by the client device for generating an appropriate user interface. The self-descriptive parameter 151′ for the travel planning workflow item can be defined as:
META_IDENTIFIED_BY=“Select1 (VisaCard|IDCard|Passport)”

Workflow manager 200 can then process all self-descriptive parameters starting with ‘META’. Ignoring these parameters would deliver the same result as not using the self-descriptive part of the workflow item.

When the workflow manager 200 processes the META_IDENTIFIED_BY parameter, ‘Select1’ can be identified as a keyword for generating a drop-down box. From this parameter, the device independent representation 251 can be generated as the following XML code:

<select1>

<label>VisaCard</label>
<label>IDCard</label>
<label>Passport</label>

</select1>

According to one example, the XML code is compliant with the x-forms standard of W3C (http://www.w3.org/MarkUp/Forms/).

The client device 910, 920 (e.g., desktop, PDA, laptop, mobile phone) can then retrieve this code over a HTTP connection.

According to one embodiment, the client devices 910, 920 run generic programs that interpret XML tags. For example, some client devices, such as PDAs and mobile phones have embedded browsers, such as HTML- or WML-browsers. To interpret the device independent representation 251 the browser renders the device independent representation 251 (e.g., x-forms XML) into a browser compatible device specific representation 251a, 251b. In an alternative implementation, a Java Server Page (JSP) parses the content of the device independent representation 251 at the client device and renders a corresponding device specific representation (e.g., a HTML page) 251a, 251b. The ‘generic program’ (e.g., JSP or browser) knows how to render because the device independent representation 251 includes all necessary information. References on client side generic program implementations can be found on the W3C x-forms web site at http://www.w3.org/MarkUp/Forms/, chapter “XForms Implementations”.

In the above XML example, the <select1> tag is rendered as a drop-down box.

A workflow manager consistent with embodiments of the invention may generate device-independent representations of workflow items based on a self-descriptive part of the workflow items. These device-independent representations can be directly transformed into device specific representations for a variety of client devices. No complex runtime analysis is required. Further, no complex transformation rules are needed to transform the abstract UI description layer into a device compliant description because this is automatically achieved by generic programs, as described above.

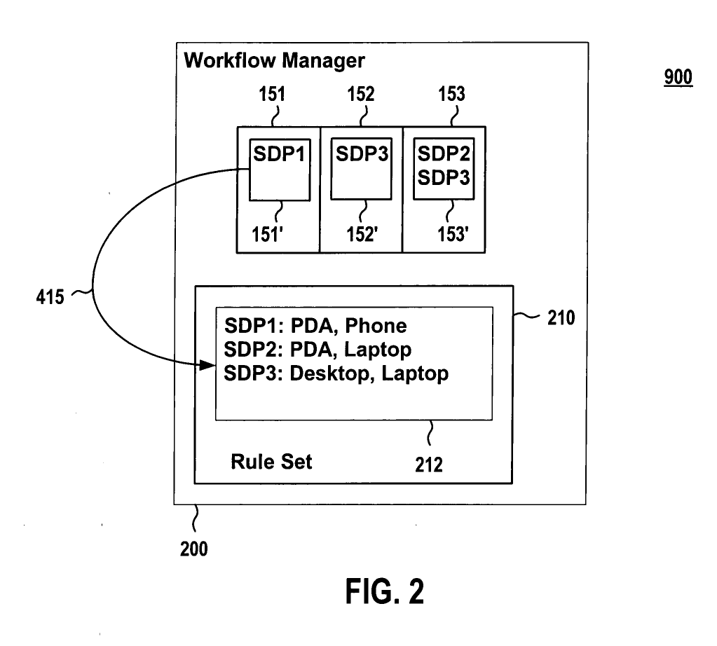

FIG. 2 shows details of an exemplary implementation of the workflow manager 200 having a rule set 210. The rule set 210 includes representation rules 212 for evaluating 415 whether a specific self descriptive workflow item 151 is suitable for a specific client device 910, 920.

In the example of FIG. 2, the representation rules 212 include rules to check the self-descriptive parts 151′, 152′, 153′ for the existence of self-descriptive parameters SDP1, SDP2, SDP3. The rules 212 indicate that a workflow item that includes SDP1 is suitable for a PDA or a mobile phone. This may be the case when the workflow item is part of a pure mobile scenario where it does not make sense to execute the workflow item on a non-mobile device. Further, a workflow item that includes SDP2 is suitable for a PDA or a laptop but not for a mobile phone. For example, the required display area for the corresponding UI may be too large for a mobile phone display. Further, a workflow item that includes SDP3 is suitable for a desktop computer or a laptop, but not for the mobile devices. For example, the required computing power for executing the workflow item may be too large for mobile devices.

In this example, the workflow manager evaluates 415 that the first workflow item including SDP1 is suitable for PDAs and mobile phones. The second workflow item 152 including SDP3 is suitable for desktop computers or laptops. The third workflow item SDP3 is suitable for PDAs, desktop computers or laptops. The rules can equally be defined for device categories and specific devices.

When a device 910, 920 connects to the workflow manager 200, the workflow manager 200 detects the device and can determine the meaningful workflow items for the device/device category. The rule set 210 can thus be used for filtering the self descriptive workflow items 151, 152, 153 to allow specific tasks depending upon the capabilities of the corresponding client device 910, 920.

According to one embodiment, the rule set 210 can be enhanced by user specific rules so that the filtering can be performed also in response to characteristics defined by the user. For example, a user might add user specific rules to prevent his/her particular mobile device from retrieving workflow items having a low priority in order to save these items to be processed later with a desktop computer in the office.

An example of a rule for avoiding large workflow items being sent to devices with a small display area can be implemented like:
If (WorkflowItem.getSize( )<=RequestingDevice.getMaxSize( )) return WorkflowItem;

The adaptation to the corresponding UI will be done automatically, as the client device gets the device-independent XML file format, and uses one of the previously described generic programs.

According to one embodiment, the workflow manager 200 can then mark or flag the workflow items or their device independent representations according to the result of the evaluation 415. Dependent on the marking, only suitable workflow item representations are retrieved from the workflow manager 200 by the corresponding client devices, whereas in a conventional workflow system a client device would try to retrieve all of the items for its user.

According to one embodiment, the rules of the rule set 210 can be set up to reflect a corporate policy and individual preferences. In other words, a subset of the rules are set as a framework that is valid for any user. For example, a company might want to change the size of the workflow items that a client device might receive for reasons, such as, deactivating certain classes of devices for security reasons, etc. Within the framework a user can define rules to reflect a user policy. The user policy is a personal tuning and applies further user-specific restrictions to what the corporate policy allows.

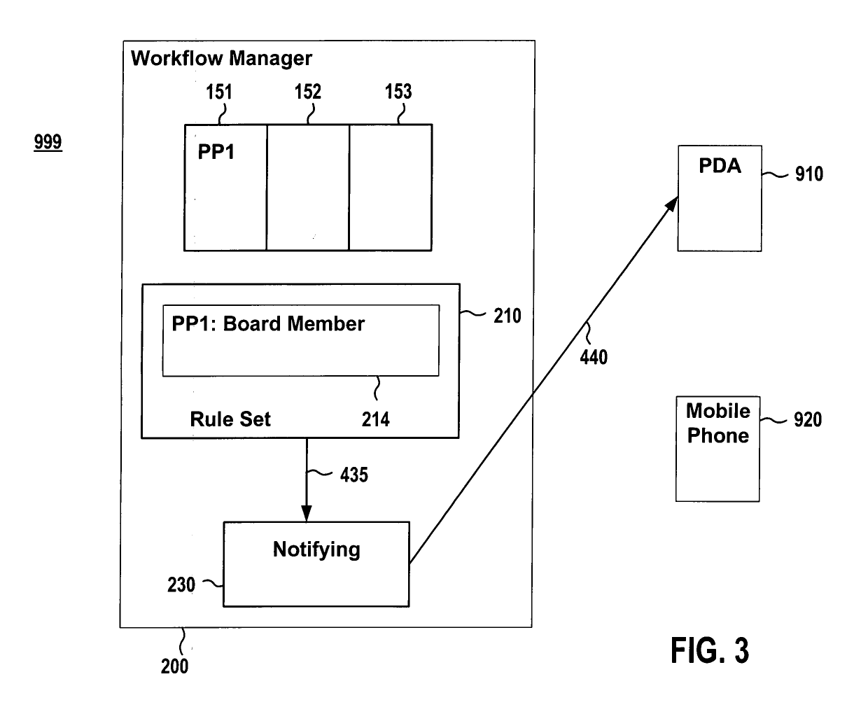

FIG. 3 shows, by way of example, the workflow manager 200 including a notifying component 230. According to one embodiment, the workflow manager 200 receives the self-descriptive workflow items from the workflow engine 100 (cf. FIG. 1) and makes the workflow items available in an inbox for a particular user.

The rule set 210 can further include notification rules 214 that, when applied to the workflow items, can request 435 from a notification component 230 of the workflow manager 200 a notification 440 to the specific client device 910, and, thereby, a notification to the user of the client device 910. For example, the notification component 230 can use SMS messages, WML pages or similar formats for notifying 440.

According to one embodiment, the notification rules 214 can depend on workflow item parameters, such as a priority parameter PP1 for board member workflow items. The priority parameter PP1 included in a workflow item 151 can then trigger an alert that is sent 440 proactively from the workflow manager as a notification to the corresponding device 910 of the affected user.

In one embodiment, the user can configure or customize the notification rules 414 by, for example, manipulating parameters of a corresponding workflow user profile. For example, the user may insert or adjust a rule for suppressing notification under specific conditions, such as: no alerts over the weekends.

The user may also define rules for automatic workflow execution. For example, if a department has a rule that vacation of up to two days will always be approved, a rule can be set up that checks a vacation request workflow item for the number of vacation days. For example, in case the number is less than 3, the workflow item may be automatically processed by the workflow manager 200 and a corresponding notification is sent to the approving manager to inform about the workflow item execution.

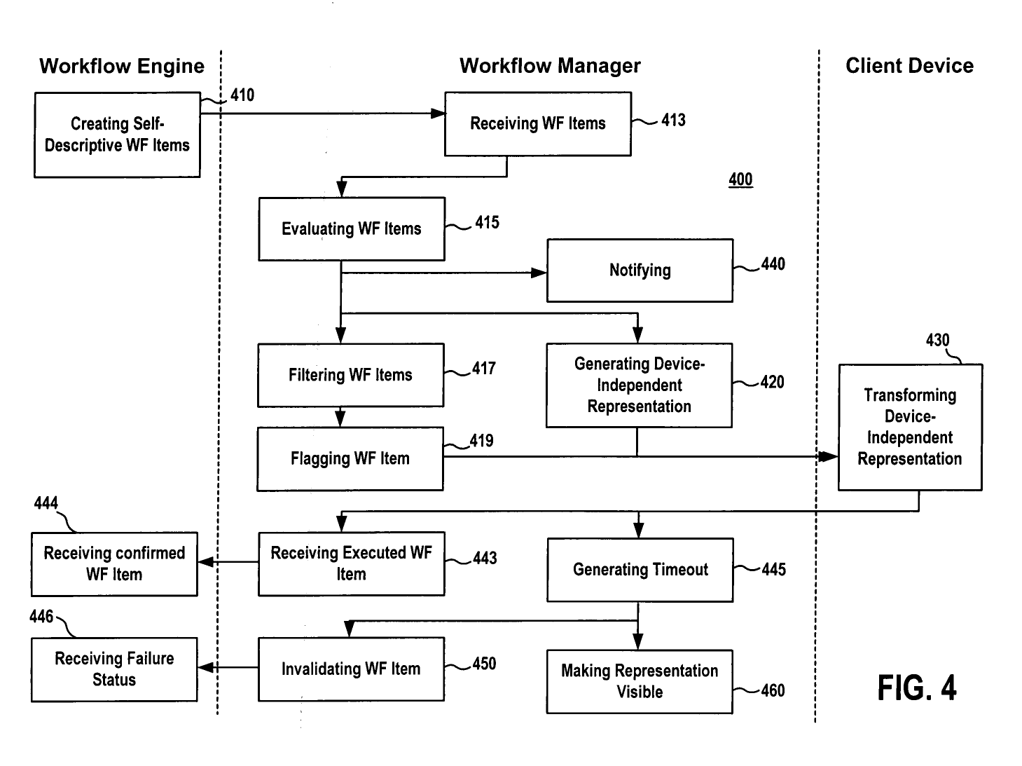

FIG. 4 is a flow chart of an exemplary method 400 for performing workflow management, consistent with an embodiment of the present invention. In other implementations, some method steps can be omitted or performed in a different order than that presented in FIG. 4.

The flowchart illustrates which method steps are executed by which component of the computer system 999. The components workflow engine, workflow manager and client device are separated by dashed lines. The various steps can be implemented as described in the description of FIGS. 1 to 3.

As a response to applications that trigger a workflow, the workflow engine creates self-descriptive workflow items (step 410).

These workflow items are then received by the workflow manager (step 413) and placed in a workflow inbox that belongs to a user who is the recipient of the workflow item.

The workflow manager 200 then evaluates the workflow items by using a rule set 210 that is applied to the self-descriptive part of the workflow item and/or to the workflow item as a whole (step 415). In some cases, such as high priority workflow items, the evaluation can cause the workflow manager to notify the user of the client device (step 440).

In some cases, for example, when a client device has insufficient capabilities for executing the workflow item, the evaluation (step 415) results in filtering the workflow items to keep only those that are suitable for the client device (step 417). The workflow items can be flagged to reflect the filtering result (step 419).

Based on the self-descriptive part of the workflow items, the workflow manager generates a device-independent representation of each workflow item (step 420).

When the client device connects to the workflow manager, it may retrieve the corresponding device-independent representation. According to one embodiment, only those representations that are flagged as meaningful for the device are retrieved.

The client device then transforms the device-independent representation into a device-specific representation (UI) by using a generic program, such as a browser (step 430).

When the device-specific representation has been executed by the client device, the executed workflow item is received by the workflow manager (step 443) and the workflow engine receives a corresponding confirmation (step 444).

When the client device does not respond within a predefined time period, the workflow manager can generate a timeout (step 445). For example, for timeout generation the workflow manager launches a timer for each workflow item when retrieved by a client device. The timeout can cause the workflow manager to invalidate the workflow item (step 450) and to return the workflow item to the workflow engine where it is received with a failure status (step 446).

The timeout generation can also cause the workflow manager to make the device independent representation of the workflow item visible again so that a further client device can retrieve the workflow item (step 460).

The further client device may belong to the same user. It may also belong to a further user who has a similar role as the user and who is also in a position to execute the workflow item. Information about substitute users can be stored in a workflow user profile or can be dynamically determined by user-to-role assignments by selecting the further user from a list of users who are assigned to the same role as the original recipient.

Embodiments of the invention can be implemented in digital electronic circuitry, or in computer hardware, firmware, software, or in any combinations thereof. Embodiments of the invention can be implemented as a workflow management computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A workflow management computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer are at least one processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (LAN) and a wide area network (WAN), e.g., the Internet.

Computing systems consistent with the invention can include clients and servers. A client and server are generally remote from each other and typically interact through a communication network. The relationship of client and server arises by virtue of computer programs running on the respective computers and having a client-server relationship to each other.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A computer system for workflow management, the system comprising:
a workflow engine for creating workflow items; and
a workflow manager for generating device independent representations of the workflow items;
wherein a workflow item comprises a self descriptive part that specifies details for generating a corresponding device independent representation.

2. The computer system of claim 1, wherein the self descriptive part comprises metadata for defining at least a part of the semantics of the workflow item.

3. The computer system of claim 1, further comprising:
a client device for transforming a device independent representation into a device specific representation.

4. The computer system of claim 2, further comprising:
a client device for transforming a device independent representation into a device specific representation.

5. The computer system of claim 3, where the client device is a mobile device.

6. The computer system of claim 4, where the client device is a mobile device.

7. The computer system of claim 3, where the client device uses a generic program for transforming.

8. The computer system of claim 4, where the client device uses a generic program for transforming.

9. The computer system of claim 1, where the workflow manager has a rule set comprising representation rules for evaluating whether a specific self descriptive workflow item is suitable for a specific client device.

10. The computer system of claim 9, where the specific client device is configured to retrieve the corresponding self descriptive representation of the specific workflow item.

11. The computer system of claim 10, further comprising:
a notification component for notifying the specific client device if requested by notification rules of the rule set.

12. The computer system of claim 11, where the rule set comprises further rules to suppress the notifying under specific conditions.

13. The computer system of claim 12, where the notification component uses a SMS message for notifying.

14. The computer system of claim 12, where the notification component uses a WML page for notifying.

15. The computer system of claim 9, where the workflow manager is configured to invalidate the specific workflow item when a timeout indicates that the specific client device did not respond within a predefined time period.

16. A computer implemented workflow management method, the method comprising the steps of:
receiving workflow items having a self descriptive part specifying details for a device independent representation of the respective workflow item; and
generating the device independent representation by using the self descriptive part, the device independent representation comprising a base for transformation into a device specific representation.

17. The method of claim 16, where the self descriptive parts comprise metadata for defining at least a part of the semantics of the corresponding workflow items.

18. The method of claim 16, comprising the further step of:
evaluating whether a specific self descriptive workflow item is suitable for a specific client device by applying representation rules to the self descriptive part.

19. The method of claim 18, comprising the further step:
notifying the specific client device if requested by notification rules.

20. The method of claim 19, where the notifying step comprises sending a SMS message to the specific client device.

21. The method of claim 19, where the notifying step comprises sending a WML page to the specific client device.

22. The method of claim 19, comprising the further step of:
invalidating the specific workflow item when a timeout indicates that the specific client device did not respond within a predefined time period.

23. The method of claim 22, comprising the further step of:
making the device independent representation of the specific workflow item visible to a suitable further client device after the timeout.

24. A computer program product comprising a computer-readable medium, the computer-readable medium comprising instructions suitable for carrying out a method for workflow management, the method comprising:
receiving workflow items having a self descriptive part specifying details for a device independent representation of the respective workflow item; and
generating the device independent representation by using the self descriptive part, the device independent representation comprising a base for transformation into a device specific representation.

25. The computer program product of claim 24, where the self descriptive parts comprise metadata for defining at least a part of the semantics of the corresponding workflow items.

26. The computer program product of claim 24, wherein the method further comprises the step of:
evaluating whether a specific self descriptive workflow item is suitable for a specific client device by applying representation rules to the self descriptive part.

27. The computer program product of claim 26, wherein the method further comprises the step of:
notifying the specific client device if requested by notification rules.

28. The computer program product of claim 27, where the notifying step comprises sending a SMS message to the specific client device.

29. The computer program product of claim 27, where the notifying step comprises sending a WML page to the specific client device.

30. The computer program product of claim 27, wherein the method further comprises the step of:
invalidating the specific workflow item when a timeout indicates that the specific client device did not respond within a predefined time period.

31. The computer program product of claim 30, wherein the method further comprises the step of:
making the device independent representation of the specific workflow item visible to a suitable further client device after the timeout.
